(19) United States
(12) Patent Application Publication
(10) Pub. No.: US 2014/0179377 A1
(43) Pub. Date: Jun. 26, 2014

(54) MOBILE ELECTRONIC DEVICE HAVING PROGRAM NOTIFICATION FUNCTION AND PROGRAM NOTIFICATION METHOD THEREOF

(71) Applicant: Pantech Co., Ltd., Seoul (KR)

(72) Inventors: Chang-Jun Song, Seoul (KR); Young-Han Kim, Seoul (KR); Hyung-Ju Lee, Seoul (KR)

(73) Assignee: Pantech Co., Ltd., Seoul (KR)

(21) Appl. No.: 14/136,612

(22) Filed: Dec. 20, 2013

(30) Foreign Application Priority Data
Dec. 20, 2012 (KR) 10-2012-0149928

(51) Int. Cl. H04W 4/20

(52) U.S. Cl. CPC H04W 4/20
USPC 455/566

(57) ABSTRACT

A mobile terminal to provide an interface for user notification includes a memory to store an application, the application providing a notification request in response to an event, a controller to receive the notification request and, in response to the notification request, to process notification information based on a user-configured notification policy, and an output device to output the processed notification information associated with the application.

### CROSS-REFERENCE TO RELATED APPLICATION(S)

This application claims priority from and the benefit under 35 U.S.C. §119(a) of Korean Patent Application No. 10-2012-0149928, filed on Dec. 20, 2012, which is hereby incorporated by reference for all purposes as if fully set forth herein.

### BACKGROUND

1. Field

The following description relates to a mobile electronic device, and more particularly, to a mobile electronic device having a program notification function, and a program notification method thereof.

2. Discussion of the Background

With the development of information and communication technologies, various types of electronic devices have been created. Among them, particularly mobile electronic devices, such as smart phones, or tablet PCs, on which a mobile operating system (OS) is mounted, have been used by many users in recent years. Examples of popular mobile operating systems include Android™, iOS®, Windows® mobile, and the like. Those OSes have been upgraded and performances of the OSes have been improved by the upgrades of the versions.

Various programs may be installed on a mobile OS to execute functions essential for using mobile electronic devices, and other various functions desired by a user. While some programs provided by mobile electronic device manufacturers and/or telecommunications service providers are pre-installed on mobile electronic devices, a user may directly install various programs on their mobile electronic devices according to their needs and preferences. As performance of a mobile operation system improves, the number of programs, which may be installed thereon, increases with the diversification of program types, and functions thereof have been advanced.

Many mobile operating systems, including Android™, provide a function of program notification (hereafter, simply referred to as “notification”), with a purpose of providing a user with specific information, e.g., notification information of a specific program, regardless of whether the program is executed or not. For example, if there is a specific event (e.g. missed calls, received messages or e-mails, software updates, etc.) in a program to be indicated to a user, the occurrence of the event may be indicated to a user using a notification function, regardless of whether the program is executed. With more diversified functions of programs installed on mobile electronic devices and increased number of program types installed, notification information provided by using a notification function of a mobile electronic device is more frequently indicated by the mobile electronic device. As a result, programs are designed to generate various types of notification information to be provided to a user, and the amount of notification information generated by such programs installed on mobile electronic devices increases, with more diversified types of notification information.

In order to realize such notification function, a mobile operating system, e.g. Android™ OS, is provided with a notification manager. Upon receiving a notification request from each application, the notification manager extracts notification information from data, which is received along with the request. Further, the notification manager stores the extracted notification information in an Android™ status notification buffer in sequence of requests, and the stored notification information is displayed on a display as a status indicator bar, or as a notification list.

FIG. 1A and FIG. 1B are diagrams illustrating an example of a display screen of a smartphone with a status indicator bar including notification information according to the related art. FIG. 1A illustrates a view of the whole display screen, and FIG. 1B illustrates an extended view of a status indicator bar in the display screen of FIG. 1A. Referring to FIGS. 1A and 1B, an operating system, e.g., an Android operating system, configures and displays notification information in a status indicator bar 101 disposed at the top of the display screen. More specifically, notification icons 121 of each type of notification information from installed applications may be displayed in the status indicator bar 101. Here, the notification icons refer to images that symbolize specific notification information. Further, if an input is sensed from a user to display detailed information associated with the status indicator bar 101, notification messages corresponding to each of the displayed notification icons 121 are displayed as a notification list 201 in one area of the display. Notification information (e.g. notification icons 121, notification messages included in the notification list 201, etc.) to be displayed is provided by each application along with a corresponding notification request. A user interface (UI) 301 is an interface for setting a smartphone environment, and a user interface (UI) 401 is a user interface for a menu button, a home button, and a back button.

Such notification information is displayed in sequence of the time of requests made by each application, and is displayed in a notification window, e.g., a portion of the status indicator bar 101, assigned display areas 121, 201, etc. The notification information is not removed from a display until a confirmation touch input or an instruction touch input is received to confirm the notification information. The display areas 121, 201 assigned to display notification information, particularly the notification area 121 of the status indicator bar 101, are limited in displaying a plurality of notification items. If there are many notification items to be displayed at the same time, some notification items may not be displayed all together in the assigned display areas 121, 201. For example, some notification icons, whose request is made earlier, are directly displayed, while other notification icons, whose request is made relatively later, are replaced with a mark of a specific shape (e.g. marked with a plus sign, or in dotted lines), which indicates an omission of a notification item. In this case, notification information (notification item) of which notification request is made later is not displayed in the notification area 121 of the status indicator bar 101 regardless of its importance, and, if a user does not touch the status indicator bar 101 to confirm, the user may not know which icon is omitted. Further, if information of the omitted icon is important to a user, the notification function cannot effectively indicate more important notification items.

### SUMMARY

Exemplary embodiments of the present invention provide a terminal and method for managing notification information.

Additional features of the invention will be set forth in the description which follows, and in part will be apparent from the description, or may be learned by practice of the invention.

Exemplary embodiments of the present invention provide a mobile terminal to provide an interface for user notification, including: a memory to store an application, the application providing a notification request in response to an event; a controller to receive the notification request and, in response to the notification request, to process notification information based on a user-configured notification policy; and an output device to output the processed notification information associated with the application.

Exemplary embodiments of the present invention provide a method for providing an interface for user notification, including: storing an application, the application providing a notification request in response to an event; receiving the notification request; in response to the notification request, processing notification information based on a user-configured notification policy; and outputting the processed notification information associated with the application.

Exemplary embodiments of the present invention provide a non-transitory computer-readable recording medium including an executable program for instructing a computer, when executed by the computer, to perform: storing an application, the application providing a notification request in response to an event; receiving the notification request; in response to the notification request, processing notification information based on a user-configured notification policy; and outputting the processed notification information associated with the application.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A and FIG. 1B are diagrams illustrating an example of a display screen of a smartphone with a status indicator bar including notification information according to the related art.

FIG. 2 is a block diagram illustrating an example of a configuration of a mobile electronic device having a notification function according to an exemplary embodiment of the present invention.

FIG. 3A and FIG. 3B are block diagrams illustrating the notification manager illustrated in FIG. 2 on an operating system of a mobile electronic device according to an exemplary embodiment of the present invention.

FIG. 4A, FIG. 4B, and FIG. 4C are diagrams illustrating an example of a user interface for setting a time range during which notification information may be displayed in the notification window according to an exemplary embodiment of the present invention.

FIG. 5A, FIG. 5B, FIG. 5C, and FIG. 5D are diagrams illustrating an example of a user interface for setting priorities for displaying a plurality of notification information in a notification window according to an exemplary embodiment of the present invention.

FIG. 6A, FIG. 6B, and FIG. 6C are diagrams illustrating an example of a user interface for setting notification information to be displayed in a notification window according to an exemplary embodiment of the present invention.

FIG. 7A and FIG. 7B are diagrams illustrating an example of a display screen of a smartphone in which notification information is displayed according to an exemplary embodiment of the present invention.

FIG. 8 is a flowchart illustrating an example of a notification method of a mobile electronic device according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. Throughout the drawings and the detailed description, unless otherwise described, the same reference numerals will be understood to refer to the same respective elements, features, and structures. The relative size and depiction of these elements may be exaggerated for clarity, illustration, and convenience.

The terminology used herein is for the purpose of describing particular embodiments only and is not intended to be limiting of the present disclosure. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item; similarly, the use of plural terms does not necessarily require plural items and may be understood as one item as need. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Notification information may refer to information of programs installed on a mobile electronic device, which is indicated when a specific event occurs regardless of whether the program is executed or not. A type of specific event that generates “notification information” is not particularly limited, and may be determined, for example, by a developer of the program, and/or may be predetermined by a mobile operating system on which the program is installed. In the former case, the event may be an event (e.g., missed calls, or received messages) that is intrinsic to a specific program. In the latter case, the event may be an event (e.g., update files present in a program, or completion of updates) that is common to various programs.

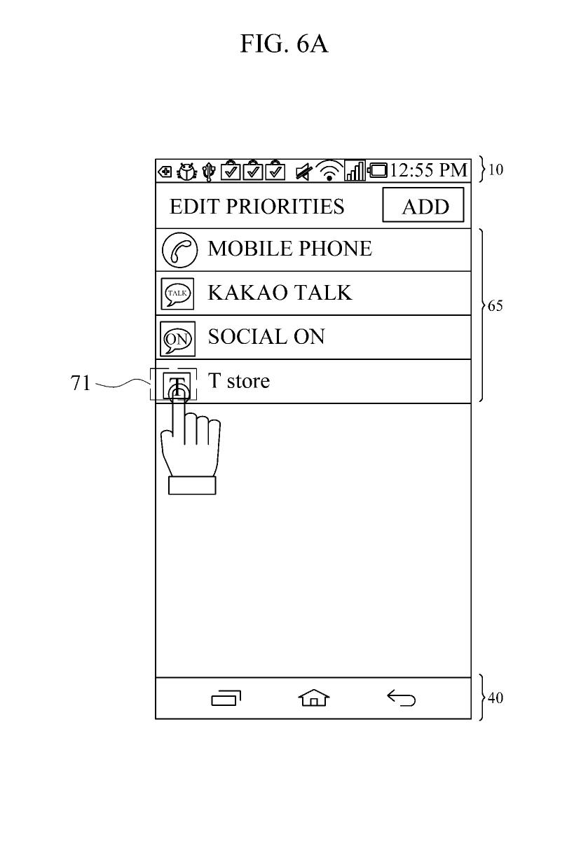

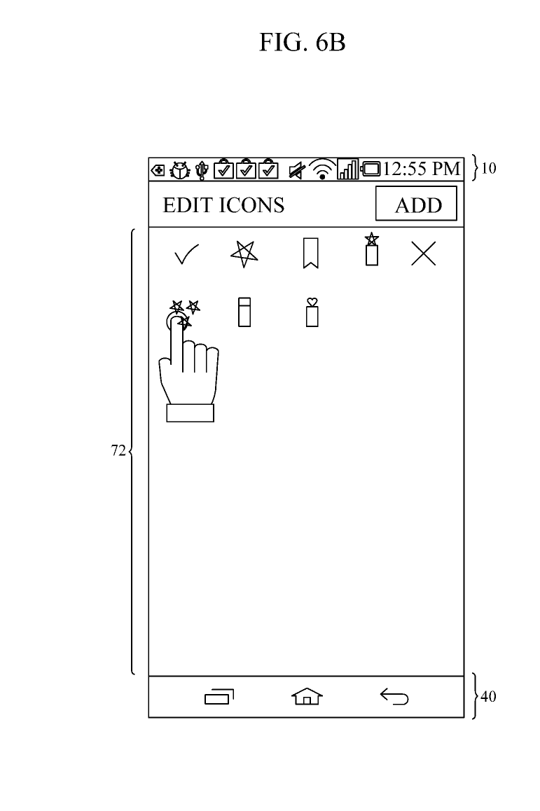

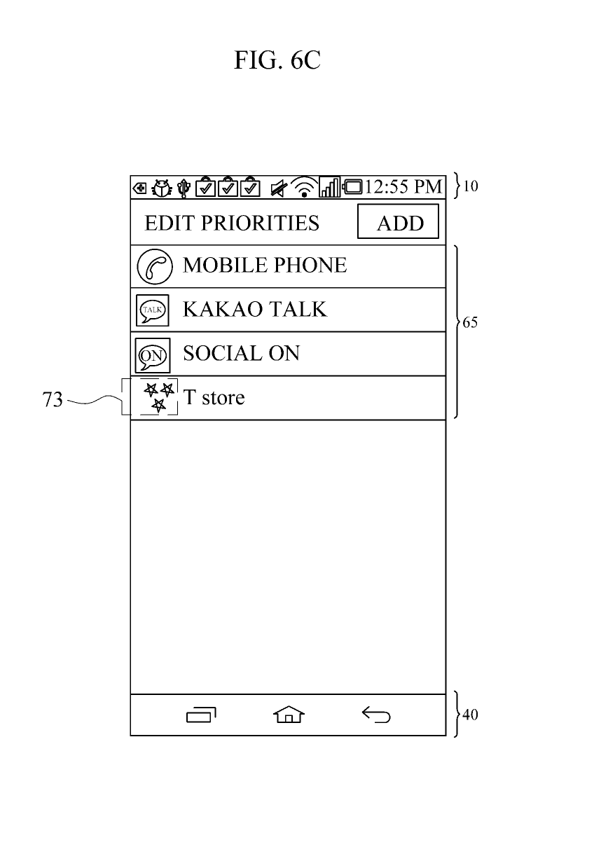

Further, details of “notification information” may be determined by a developer of the program, and/or may be predetermined by a mobile operating system on which the program is installed. Programs that request notification generally provide “notification information” along with the notification requests. In the following description, “notification information (hereinafter, referred to as “represented notification information”) corresponding to notification requests” may be identical to notification information (hereinafter, referred to as “source notification information”) provided by a program that requests notification, or may be other notification information (e.g., other notification icons selected by a user to replace notification icons included in notification requests, as illustrated in FIG. 6A to FIG. 6C and described below), which is set by a user to correspond to the source notification information by one-on-one mapping. In this case, only a method for displaying notification information (e.g., displaying icons or notification messages) may be changed, and substantive details of source notification information and represented notification information may be unchanged.

A “notification window” refers to one area of a display of a mobile electronic device where the above-mentioned “notification information” is displayed. More specifically, “notification information” may be represented notification information in the notification window. Hereinafter, “notification information” may be “source notification information” or “represented notification information” in accordance with the context of the description. A position and size of the “notification window” may generally be preinstalled or predefined by a mobile operating system mounted on a mobile electronic device. However, the position and/or size of the “notification window” may be reconfigured. For example, the position and/or size of the “notification window” may be determined depending on a display status at a time when the “notification information” is displayed or depending on the number of pieces of “notification information” to be displayed at the same time.

Further, the “notification window” may not be limited to one area of a display, and may include two or more areas. For example, the number of display areas included in the “notification window” may be varied depending on a type of a mobile operating system. In an example (a case of Android™ operating system), both a display area where a status indicator bar is displayed and a display area where a notification list is displayed correspond to the “notification window”. In this case, each of a notification icon displayed in the status indicator bar and a notification message displayed in the notification list corresponds to an item of “notification information.”

Further, as described above, a “notification window” may include two or more display areas. For example, a status indicator bar may be displayed all the time if the display is in an unlocked state, and a notification list may be additionally displayed in an area other than the area of the status indicator bar when a user's input to the status indicator bar is sensed. Further, a plurality of notification windows may be displayed in the display, or two or more notification windows may be displayed alternatively in the same area (in this case, the size of notification windows may be different from each other).

A mobile electronic device, such as a mobile terminal, may include hardware components, such as one or more processors, a memory, a touch screen display, a camera, and the like. Also, the units, modules, elements, applications, and components of the apparatuses, systems, and/or terminals herein described, may include hardware and software, may also include firmware, to perform various operations of the terminal including those described herein, may be combined or remain separate, and may be stored in one or more storage devices or computer-readable media. According aspects of the invention, a device may be a mobile terminal, a cellular telephone, a smartphone, a tablet computer, a laptop computer, a desktop computer, and the like.

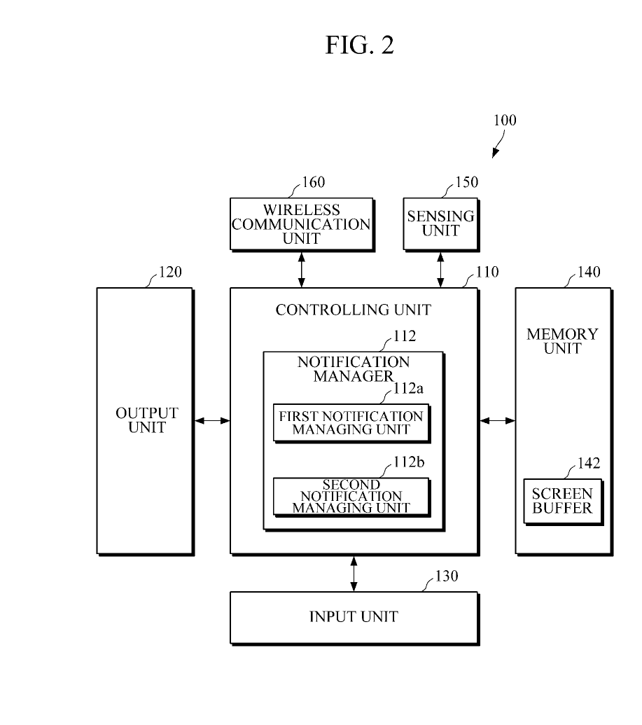

FIG. 2 is a block diagram illustrating an example of a configuration of a mobile electronic device having a notification function according to an exemplary embodiment of the present invention. A mobile electronic device 100 illustrated in FIG. 2 is a mobile terminal in which a specific mobile operating system is mounted, such as a smartphone, or a tablet computer, and the like. The mobile electronic device 100 may be a personal multimedia player (PMP), a game console, a navigation device, or an e-book reader, on which a specific mobile device operating system is mounted.

Referring to FIG. 2, the mobile electronic device 2 may include a controlling unit 110 that includes a notification manager 112, an output unit 120, an input unit 130, a memory unit 140 that includes a screen buffer 142, a sensing unit 150, and a wireless communication unit 160. Herein, the notification manager 112 is configured to execute a notification function for the mobile electronic device 100, and to output notification information to the output unit 120 (e.g. display) as a unit according to notification requests from installed programs. The screen buffer 142 is configured to temporarily store information to be displayed in a display, and functions as a status notification buffer to temporarily store notification information transmitted from the notification manager 112.

The mobile electronic device 100 illustrated in FIG. 2 is an example of a mobile terminal having a notification function. Therefore, the mobile electronic device 100 may not include one or more units illustrated in FIG. 2. For example, the mobile electronic device 100 may not include the sensing unit 150. Further, the mobile electronic device 100 may further include other units for specific operations, in which additional units may be configured depending on a type and function of the mobile electronic device 100. For example, the mobile electronic device 100 may further include a camera module, a vibration generation module, a Global Positioning System (GPS) module, a broadcast reception module, a wired communication module, a power supply unit, and the like.

The controlling unit 110 is configured to perform functions of managing, processing, and controlling the overall operations for the mobile electronic device 100. The controlling unit 110 may include one or more processors to perform such operations and/or functions. Further, controlling unit 110 may include a software module, e.g., a controlling module, to perform such operations in association with a hardware device, such as a processor. The controlling unit 110 may control the wireless communication unit 160 so that the mobile electronic device 100 may communicate with servers or other mobile electronic devices, such as wireless data communications, or voice/video calls, and may perform processing of transmitted and received signals. Further, the controlling unit 110 may perform controlling of operations, and processing of signals for executing a specific module or a program in the mobile electronic device 100, such as a game, playing back multimedia, or executing applications. In addition, the controlling unit 110 may perform a specific processing in response to visual, auditory, and mechanical input signals received from the input unit 130 or the sensing unit 150, and, as a result of the processing of input signals, the controlling unit 110 may control the output unit 120 to output data stored in the memory unit 140, after an execution by the controlling unit 110, as visual, auditory, and mechanical signals.

Further, the controlling unit 110 may execute one or more controlling functions to enable the mobile electronic device 100 to perform notification functions. More specifically, if there are notification requests from programs installed on the mobile electronic device 100, the controlling unit 110 may control the output unit 120 to display notification information corresponding to the notification requests in a display of the output unit 120. In this case, a display method predetermined by a user or a device configuration may be applied to notification information displayed in the display. For a user configuration, the controlling unit 110 may provide a user interface (UI) for a user to set a display method, which will be described below.

As an example of a tool for the mobile electronic device 100 to perform a notification function, the controlling unit 110 may include the notification manager 112. Upon receiving notification requests from programs installed on the mobile electronic device 100, the notification manager 112 performs a function of controlling notification information corresponding to the received notification requests to be displayed in a display notification window, according to a determined display method, or by applying the display method. The notification manager 110 may store, in the screen buffer 142, notification information corresponding to notification requests by applying a determined display method. Further, the notification manager 112 may control the output unit 120 to display notification information stored in the screen buffer 142 in a display notification window.

For example, the notification manager 112 may include a first notification managing unit 112a, and a second notification managing unit 112b. Referring to FIG. 2, the first notification managing unit 112a and the second notification managing unit 112b are implemented separately in a physical and/or functional manner, but aspects are not limited as such. In this case, the first notification managing unit 112a may be a notification management module, which is provided for implementing a conventional notification operation in a known mobile operating system (e.g. jellybean, which is Android™ OS version 4.2, or Android™ OS before and after the jellybean version, which has an identical notification function) mounted on a mobile electronic device 100. Further, the second notification managing unit 112b may be a separate notification management module, which is additionally provided to implement a notification operation by using data output from the first notification managing unit 112a. Hereinafter, the first and the second notification managing units will be described in further detail.

As a notification request from an installed program is transmitted to the notification manager 112, the first notification managing unit 112a extracts source notification information from data received along with the notification request. The notification request may generally contain source notification information, such as notification icons to be displayed in a status indicator bar, and notification messages to be included in a notification list, as well as intrinsic notification information (e.g., a program identification (ID)), such as operations to be performed when an input of notification messages is sensed. Further, the first notification managing unit 112a outputs one or more pieces of the extracted source notification information as it is, ensuring that any one is not omitted. More specifically, the first notification managing unit 112a may not filter the requests and may process to output all pieces of notification information according to notification requests if output resources are available, e.g., a remaining display space in the status indicator bar is available. If there is a plurality of extracted source notification information to be output, the first notification managing unit 112a outputs the information in sequence of requests.

The second notification managing unit 112b outputs notification information corresponding to a source notification request, e.g., represented notification information, so as to display received source notification information in a notification window of a display by applying a display method determined by a user. As described above, represented notification information may be identical to received source notification information, or may be other notification information that replaces the source notification information according to a determined display method. In this case, the display method may include displaying notification information by setting priorities for displaying a plurality of represented notification information in a notification window, setting a time range during which represented notification information may be displayed in a notification window, setting a white list and/or a black list regarding whether to display specific represented notification information in a notification window, setting types of notification icons that symbolize specific represented notification information, and the like.

A conventional mobile electronic device includes only a general notification managing unit as a notification manager without providing the second notification managing unit 112b or providing additional functionalities to customize notification functions or to provide enhanced notification management. Therefore, the conventional notification manager displays source notification information, which is output from e.g., the first notification managing unit 112a, without further processing. If there is a large amount of notification information to be displayed, only a part thereof is displayed in a notification window according to a sequence of requests (in this case, the rest of the notification information is not displayed directly, but is displayed with a mark indicating an omission, such as a plus icon, or a “view more” menu button). According to aspects of the present invention, a mobile electronic device may further include the second notification managing unit 112b, so that a plurality of represented notification information may be displayed in a notification window according to determined priorities, without solely relying upon a sequence of requests. Further, represented notification information may be displayed according to a specific time setting. Specific notification information may be selectively displayed according to a notification enable/disable setting. Further, changed notification icons may be displayed, instead of default notification icons provided by corresponding programs.

The notification managing unit 112 may be implemented as one integrated unit, in which the first notification managing unit 112a and the second notification managing unit 112b do not have separate operations or functions. In this case, the notification manager 112 receives source notification information along with notification requests from installed programs. Further, the notification manager 112 controls represented notification information to be displayed in a notification window by applying a determined display method. Structures and functions of the notification manager may be implemented by, for example, a new notification management module provided by a new mobile operating system mounted on a mobile electronic device, e.g., a notification management module that performs the same operations as the notification manager 112.

Hereinafter, an example of the notification manager 112 of a mobile electronic device will be described. Generally, a mobile electronic device includes layers, such as a hardware layer, a platform that processes signals input from the hardware layer, and an application layer having various applications that operate based on the platform. The platform may be an Android™ platform, a Windows® mobile platform, an iOS® platform, and the like, according to an operating system of a mobile electronic device, in which the platforms have structures slightly different from each other, but may perform similar functions. The Android™ platform includes a Linux kernel layer, a library layer, and a framework layer. The Windows® mobile platform includes a Windows® Core layer and an interface layer. Further, the iOS® platform includes a Core OS layer, a Core service layer, a media layer, and a Cocoa Touch layer. Each layer may be indicated as a block, and a framework layer of the Android™ platform, or similar layers of other platforms may be defined as a software block.

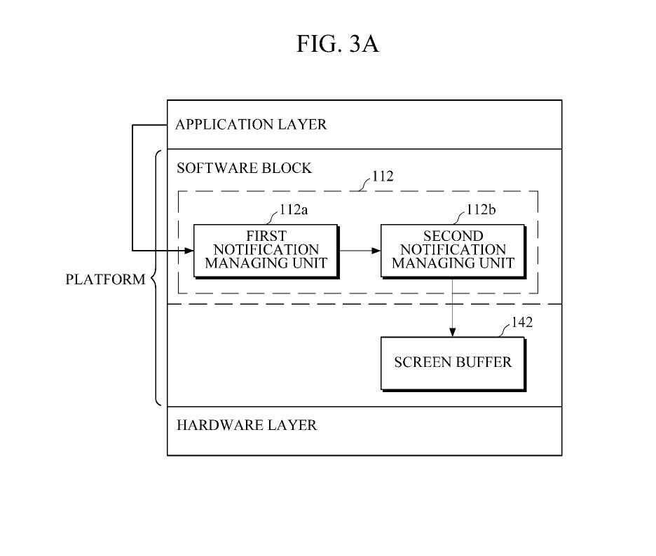

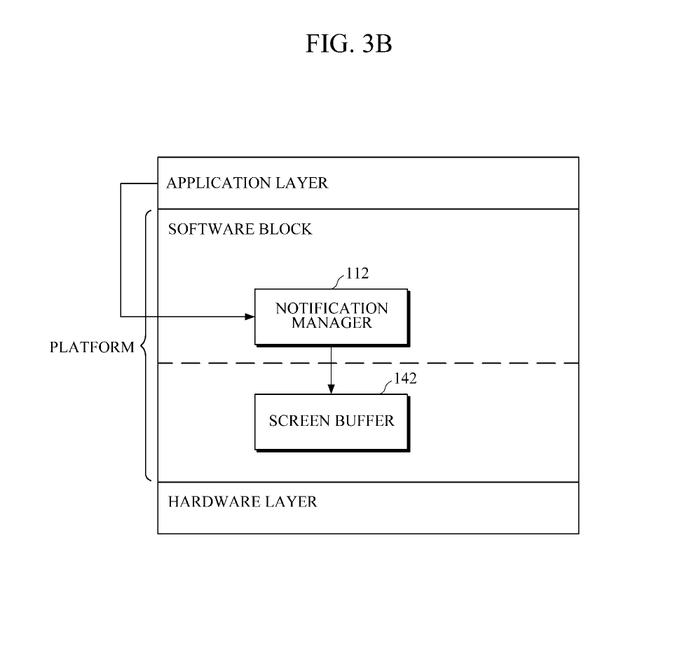

FIG. 3A and FIG. 3B are block diagrams illustrating the notification manager in FIG. 2 on an operating system of a mobile electronic device according to an exemplary embodiment of the present invention. FIG. 3A illustrates an example of a notification manager 112 that includes a first notification managing unit 112a and a second notification managing unit 112b (see FIG. 2), and FIG. 3B illustrates an example of a notification manager in which functions of the notification manager 112 are integrated. FIG. 3A and FIG. 3B will be described with regard to an example of a mobile electronic device including an Android™ operating system, but aspects are not limited thereto. Further, a screen buffer 142 in FIG. 3A and FIG. 3B corresponds to the screen buffer 142 included in the memory unit 140 in FIG. 2, and the screen buffer 142 may temporarily store represented notification information to be displayed in a notification window. Referring to FIG. 3A, the notification manager 112 further includes a second notification managing unit 112b, which is installed between a first notification managing unit 112a that performs a notification management including operations of a conventional notification manager and the screen buffer 142. Referring to FIG. 3B, in the notification manager 112, functions and/or operations of the first and the second notification managing units 112a and 112b are integrated in one unit.

As described above, the notification manager 112 may control represented notification information to be displayed in a notification window according to a display method determined by a user or by applying the display method. In order to implement such functionalities, the controlling unit 110 (see FIG. 2) may control the output unit 120 and the input unit 130 to provide a user interface (UI) for a user to determine a display method of notification information. A type of a method for displaying notification information may be determined by a user. As described above, the display method may include priorities for displaying a plurality of represented notification information in a notification window, a time range during which represented notification information may be displayed in a notification window, a white list and/or black list regarding whether to display specific represented notification information in a notification window, types of notification icons that symbolize specific represented notification information, and the like. The white list may include notifications of applications allowed to be displayed in a notification area of a status indicator bar, a notification list, and the like. The black list may include notifications of application prohibited from displaying in one or more notification areas, such as the notification area of the status indicator bar, the notification list, or other notification resources and areas.

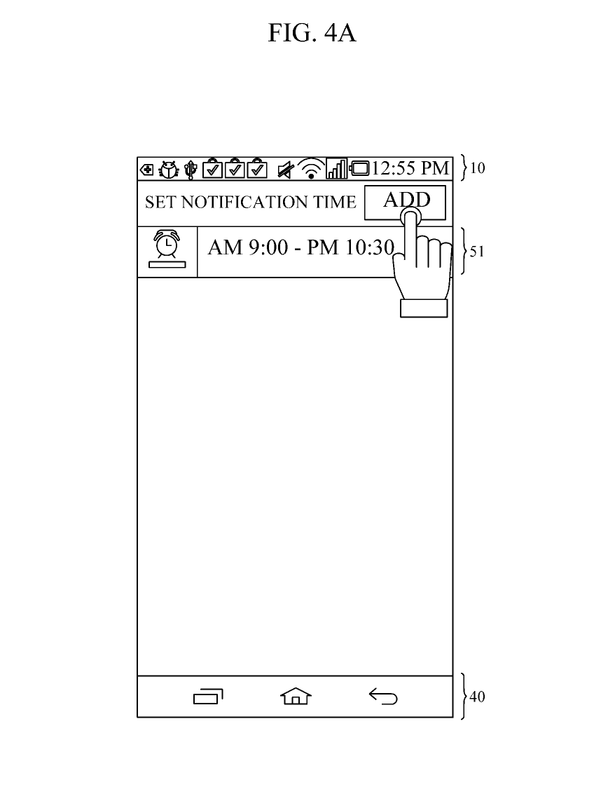

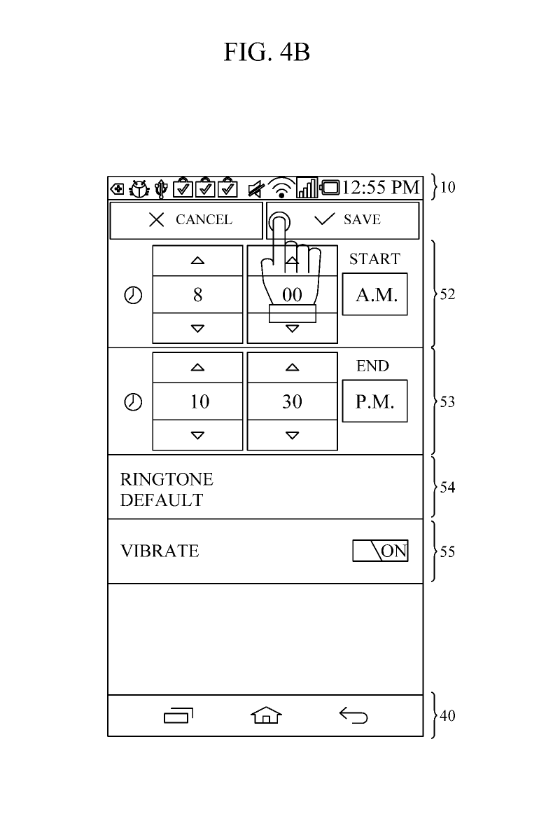

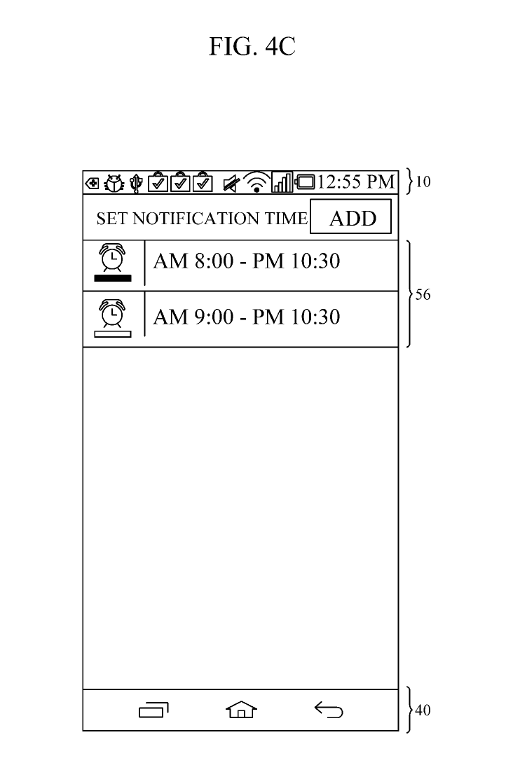

FIG. 4A, FIG. 4B, and FIG. 4C are diagrams illustrating an example of a user interface for setting a time range during which notification information may be displayed in the notification window. The user interface (UI) for setting a time range as illustrated in FIG. 4A to 4C may be a user interface for all the installed programs, or a part thereof (e.g. for each program, each category of the programs, one or more grouped applications, a grouped categories of one or more applications, etc.). Further, FIG. 4A to 4C illustrate an example of “setting a display time,” a time range during which represented notification information is displayed in a notification window, and may be applied to a case of setting a “non-display time,” a time range during which notification information is not displayed in a notification window. In FIG. 4A to 4C, a status indicator bar 10 includes a notification window, and an example of a user interface (UI) 40 includes a menu button, a homfe button, and a back button.

Referring to FIG. 4A, a user selects an “add” menu through a user interface (UI) for “setting a notification time” displayed in a display (see a section selected by a user). FIG. 4A illustrates a method of setting an additional time, in addition to a first notification time 51 (9:00 a.m. to 10:30 p.m.). As illustrated in FIG. 4A and FIG. 4B, if an “add” menu is selected, a user interface 52, 53 for setting a start time and an end time of a notification time may be displayed on a display. Further, if a start time (8:00 a.m.) and an end time (10:30 p.m.) are set by a user through the user interface 52, 53, and then a “save” menu is selected, a second notification time (8:00 a.m. to 10:30 p.m.) is added as a newly set notification time (see the reference numeral 56 in FIG. 4C). In FIG. 4B, the reference numeral 54 denotes a user interface for setting an audible sound to indicate a notification, and the reference numeral 55 denotes a user interface for determining whether to use vibration to indicate a notification.

As described above, if a notification time is set as a display time by a user in a display method, the notification manager 112, e.g., the second notification managing unit 112b, controls notification information to be displayed in a notification window if the notification request occurs within a predetermined notification time range (in this case, depending on a user's setting, notification information may be output along with an audible sound and/or vibration to indicate the notification). If a notification time is set as a non-display time by a user, the notification manager 112, e.g., the second notification managing unit 112b, may control notification information to be displayed in a notification window if the notification request occurs at a time other than the predetermined notification time range. By the time range settings, notification information may be displayed only when a user desires to receive notification information (e.g. during a break), or may not be displayed when a user does not wish to receive notification information (e.g. during sleep).

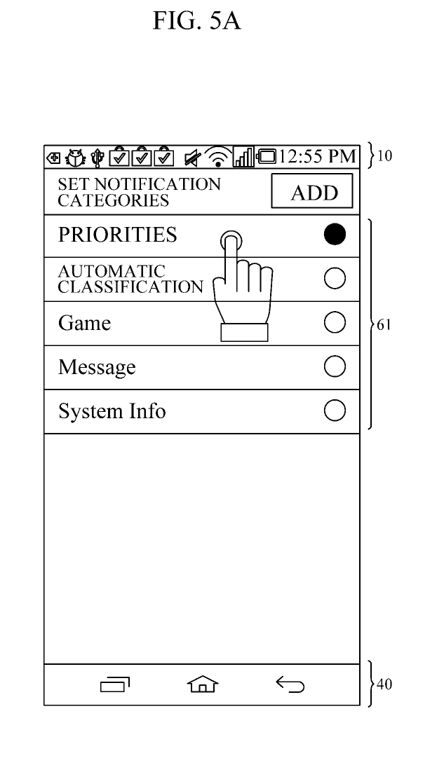

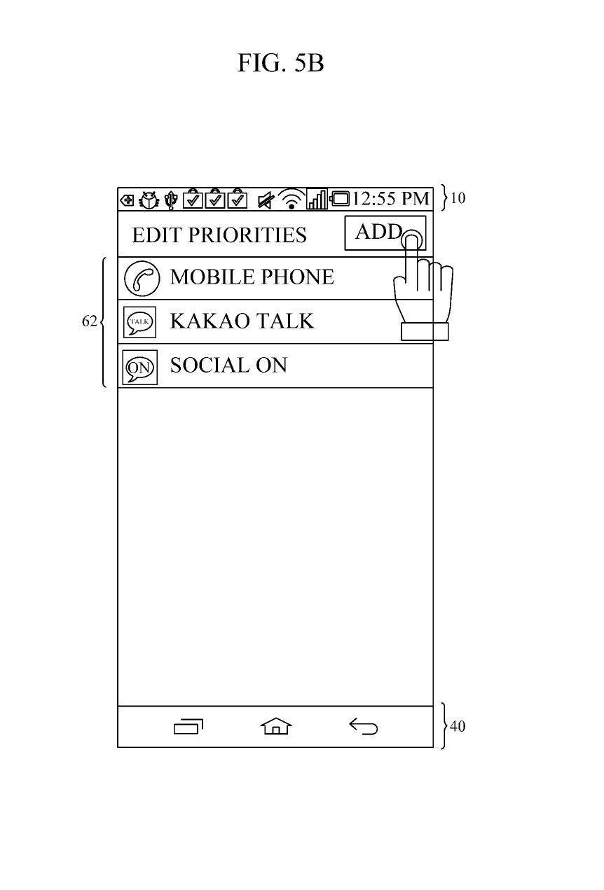

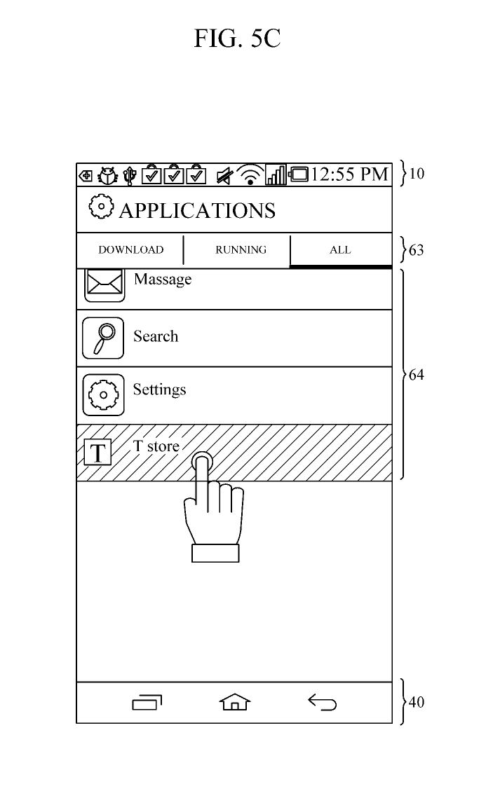

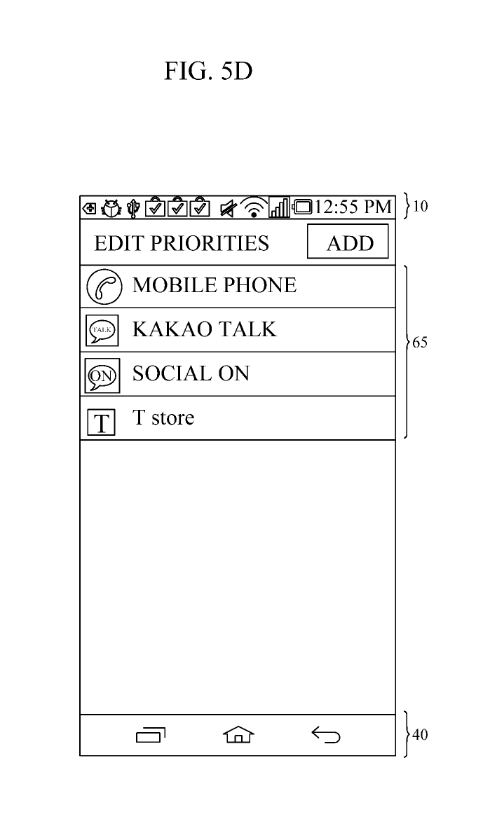

FIG. 5A, FIG. 5B, FIG. 5C, and FIG. 5D are diagrams illustrating an example of a user interface for setting priorities for displaying a plurality of notification information in a notification window according to an exemplary embodiment of the present invention. A user interface for setting priorities illustrated in FIG. 5A to 5D may be a user interface for some selected programs or all installed applications. For example, priorities may be set per category into which programs are classified. In this case, according to a priority of a category to which a program belongs, a sequence of displaying notification information requested by each program in a notification window may be determined. Further, if programs are included in one category, priorities are set for these programs, or program priorities may be set by being added to category priorities. The reference numeral 10 in FIG. 5A to FIG. 5D denotes an example of a status indicator bar including a notification window, and the reference numeral 40 denotes an example of a user interface (UI) for a menu button, a home button, and a back button.

Programs may be automatically classified into specific classifying categories (e.g. game, message, system information, multimedia, education, etc.). For example, if a user selects an “automatic classification” of the priority setting list 61 in FIG. 5A, categories of installed programs may be automatically classified. Further, a user may arbitrarily classify categories of installed programs by using a specific user interface (UI). For example, if one category menu (e.g. a game menu, a message menu, and a system info menu) of the priority setting list 61, which a user wishes to edit, is selected, programs included in the selected category may be added or deleted. A user may newly add or delete a “category” item by selecting an “add” menu below a status indicator bar 10 illustrated in FIG. 5A.

Further, referring to FIG. 5A, a “priorities” menu may be selected by a user through a user interface (UI) for “setting notification categories” displayed on a display (see a section selected by a user's finger). As described above, FIG. 5A may be a case of setting priorities for some programs selected by a user or all programs installed in the device. As illustrated in FIG. 5A, if a “priorities” menu is selected, a user interface for editing priorities is displayed as illustrated in FIG. 5B. In FIG. 5B, programs (Mobile phone, Kakao Talk, and Social ON) 62 are programs for which priorities are already set. Priorities may be set, for example, sequentially from the top to the bottom (in this case, priorities are set in sequence of “mobile phone”→“Kakao Talk”→“Social ON”). An application having a higher priority may be located at a higher position of the display. Further, if an “add” menu below the status indicator bar 10 is selected through a user interface, a list 64 of programs to be edited for resetting priorities are displayed in a display, as illustrated in FIG. 5C. The reference numeral 63 in FIG. 5C denotes a group of applications that indicates whether programs listed in the list 64 includes downloaded programs (“download” item), or running programs (“running” item), or all programs to be edited for resetting priorities (“all” item). If a “T store” program is selected as illustrated in FIG. 5C, the “T store” program may be added to programs for priority setting indicated in the list 65, which may be a modified list of the list 62 in FIG. 5B.

If priorities are set per category and/or per program by a user in a determined display method, the notification manager 112, e.g., the second notification managing unit 112b, controls a notification window to be displayed according to set priorities (in this case, depending on a user's setting, notification information may be output along with an audible sound and/or vibration to indicate notification, as described above). As a result, if there is a plurality of notification information to be displayed at the same time, (e.g., if there are many items of notification information to be displayed in a display window all together, a user may first display selected notification information according to a user's personal preference, convenience, and/or importance of the information. Therefore, notification information with higher importance or preference may be displayed in a notification window, even if a notification request thereof is made later than other notification information, and a user may know that important notification information is received without an additional check. If the notification area or space is

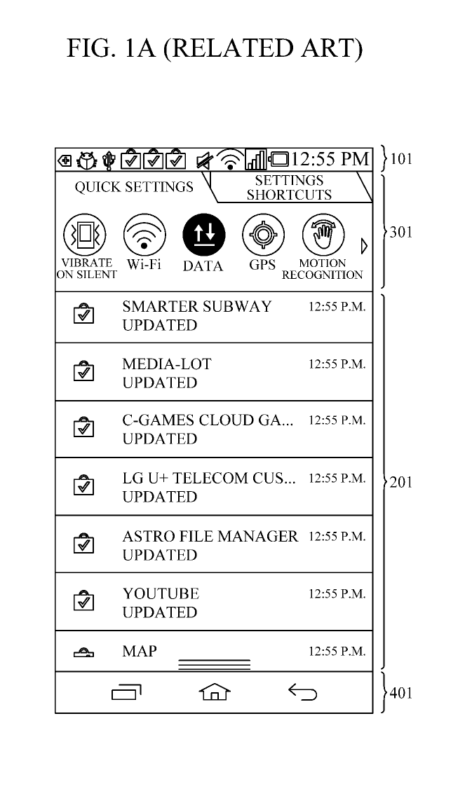

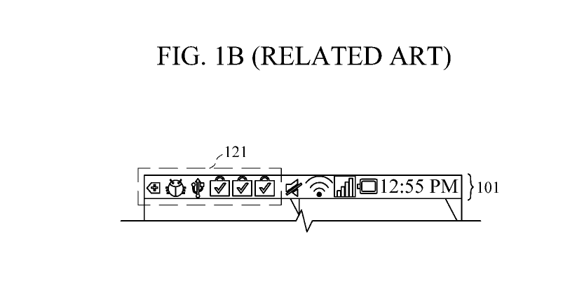

FIG. 6A to 6C are diagrams illustrating an example of a user interface for setting notification information to be displayed in a notification window according to an exemplary embodiment of the present invention. FIG. 6A to 6C illustrate an example of “notification icons,” an example of setting notification information to be displayed in a status indicator bar 10. The example illustrated in FIG. 6A to 6C may also be applied to a case of setting notification messages to be listed in a notification list (see the reference numeral 20 in FIG. 1A), or a case of setting text information to be displayed in the status indicator bar 10. The reference numeral 10 in FIG. 6A to 6C denotes an example of a status indicator bar that includes a notification window, and the reference numeral 40 denotes an example of a user interface (UI) for a menu button, a home button, and a back button.

Referring to FIG. 6A, through a user interface (UI) for “editing priorities” displayed in a display, programs that a user desires to set, or notification icons 71 that correspond to the programs, are selected (see a section selected by a user's finger). As shown in FIG. 6A, a notification icon 71 of a “T store” program is to be set among programs 65 of which “priorities can be edited.” If a notification icon 71 of an application is selected from among programs 65, a user interface (UI) 72 for “editing icons” may be displayed (see FIG. 6B). In the user interface 72, for example, many images, which may be used to replace the existing notification icon 71, may be displayed. Further, as an icon to replace the existing notification icon 71, a user may directly prepare a certain shape, or may select an image stored in other directories. Further, if a user selects a new image to be used through the user interface 72 (see FIG. 6b), a notification icon 73 of the “T store” program is changed into an image selected in FIG. 6b, as illustrated in FIG. 6C.

As mentioned above, if new images or texts are set as notification information by a user in a display method, the notification manager 112, e.g., the second notification managing unit 112b, controls newly set images or texts to be displayed in a notification window as notification information (in this case, depending on a user's setting, notification information may be output along with an audible sound and/or vibration to indicate notification, as described above). As a result, a user may display notification information of desired images or texts in a notification window.

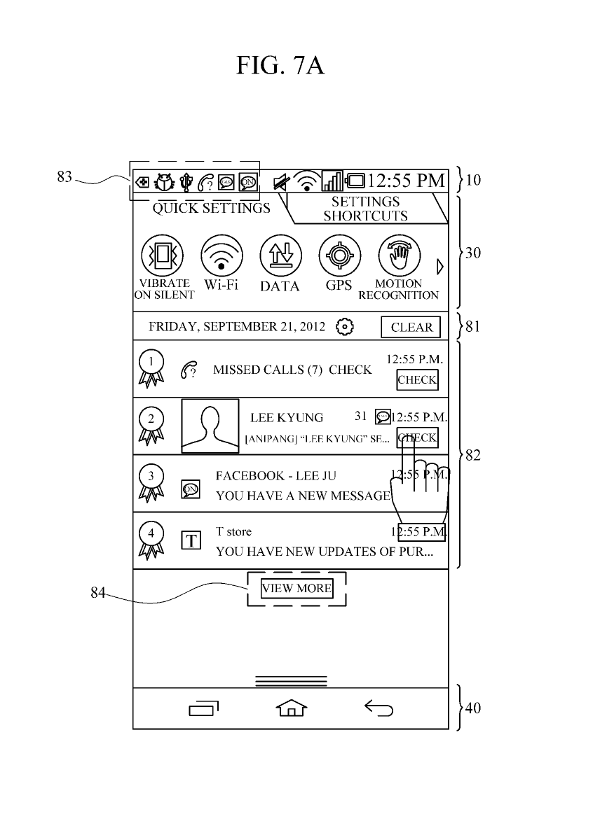

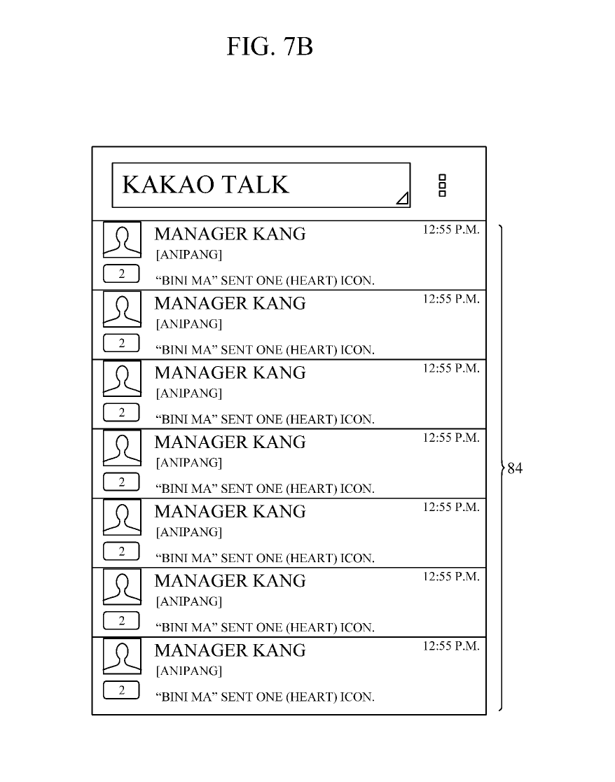

FIGS. 7A and 7B are diagrams illustrating an example of a display screen of a smartphone in which notification information is displayed according to an exemplary embodiment of the present invention. FIG. 7A illustrates a view of the whole display screen, and FIG. 7B illustrates a view of a display screen in a case where a second item in a notification list 82 in FIG. 7A is selected. The reference numeral 10 in FIG. 7A denotes a status indicator bar, and the reference numerals 30 and 40 denote a user interface (UI) for setting an environment of a smartphone, and a user interface (UI) for a menu button, a home button, and a back button, respectively.

Referring to FIG. 7A, a plurality of notification icons are displayed in a notification window 83 of a status indicator bar 10 disposed at the top of a display screen. The notification icons to be displayed in the notification window 83 are displayed in sequence of “Mobile phone” program, “Kakao Talk” program, and “Social ON” program, according to priorities (e.g. priorities illustrated in FIG. 5D) set by a user. Further, a “plus” icon indicates that there are more notification icons to be additionally displayed in the notification window 83.

Further, in the notification list 82 in FIG. 7A, notification messages are listed to be displayed in other notification windows when a user's input to the status indicator bar 10 is sensed. Notification messages, e.g., one or more items to be included in the notification list 82, may be displayed sequentially according to set priorities (e.g. priorities illustrated in FIG. 5D). As a result, only the notification information of programs, for which priorities are set, may be displayed as items of the notification list 82, such that notification information of programs having a lower priority to a user may be prevented from being displayed all together. As for an additional check of items that are not included in the current notification list 82, a user may check notification information of other programs which are omitted from the notification list 82, by touching a “view more” button 84.

Further, in the notification list 82 in FIG. 7A, if there is a plurality of notification information requested by an identical program, the plurality of notification information may not be displayed one by one, but displayed as one group of notification messages in the notification list 82. More specifically, in the notification list 82 in FIG. 7A, if there are seven pieces of notification information (missed calls) requested from a mobile phone program, which is the first priority, the entire notification information may be displayed in the notification list 82 as one item corresponding to a group of notification messages, with number 7 included in the item to show the number of overlapped or repeated notification information. Further, in the notification list 82 in FIG. 7A, if there are 31 pieces of notification information (transmission of heart icons) requested from a Kakao Talk program, which is the second priority, the entire notification information may be displayed in the notification list 82 as one item corresponding to a group of notification messages, with number 31 included in the item to show the number of overlapped or repeated notification information. Based on this description, overlapped, identical notification information may be prevented from being displayed in the notification list 82, or in a notification window therefor, which have a limited size. As a result, as much program notification information as possible may be displayed in the notification list 82 without displaying all of the repeated notification information having the same or similar notifications.

In this case, by touching a group of notification messages of the notification list 82, for example, by touching a “check” button displayed in a group of notification messages, a user may check a plurality of notification messages one by one, which constitute the group of notification messages. FIG. 7B illustrates an example of a display screen when a group of notification messages of an “Anipang” program is selected by a user as illustrated in FIG. 7A (see a section selected by a user's finger).

As described above, a display method may include a white list and/or a black list. In the former case, through a specific user interface (UI), a user may select programs, and/or categories into which programs are classified. For the selected programs in the white list, notification information is displayed in the notification window. In the latter case, through a specific user interface (UI), a user may select programs, and/or categories into which programs are classified. For the selected programs in the black list, notification information is prohibited from being displayed in the notification window. Further, if a determined display method is a white list scheme, the notification manager 112 may control only notification information of programs selected by a user and/or notification information of programs included in categories selected by a user to be displayed in the notification window. If a determined display method is a black list scheme, the notification manager 112 may control notification information of programs selected by a user and/or notification information of programs included in categories selected by a user to be filtered such that notification information for programs and/or applications in the black list is prohibited from being displayed in the notification window. For other programs and/or applications not included in the black list, notification information or notification information included in categories may be controlled to be displayed in the notification window according to one or more display methods.

As described above, if there is a notification request from a program, the mobile electronic device 100 including the notification manager 112 may display specific notification information in a notification window by applying a predetermined display method. This may be performed in a configuration in which both the first and the second notification managing units 112a, 112b of the notification manager 112 perform operations or a configuration in which an integrated notification managing unit performs the corresponding operations. Further, the mobile electronic device 100 may display source notification information, which is included in a notification request, in the notification window according to a sequence of requests and a conventional program notification method, without applying the display method. This may be a case where only the first notification managing unit 112a of the notification manager 112 operates without an operation of the second notification managing unit 112b thereof. Further, a user may determine, through a specific user interface, a method of the two operation methods described above, by which the notification manager 112 will operate. It may be determined whether the second notification managing unit 112b will operate normally. More specifically, the second notification managing unit 112b may be inactive and a default notification method set by each application may be used or the second notification managing unit 112b may be activated and may filter, modify, and/or customize the notification operations according to a method described above.

Referring back to FIG. 2, the input unit 120 and the output unit 130 constitute a user interface (UI) of the mobile electronic device 100. The input unit 120 is configured to input a user's data, input, instructions, request signals, and the like, to the mobile electronic device 100, and the output unit 130 is configured to output data, information, signals, and the like, which are processed in the mobile electronic device 100. More specifically, the input unit 120 may include a microphone for an input of voice or sound, a key pad for a user to input data or instructions to the mobile electronic device 100, a dome switch, a button, a jog wheel, a touch pad, and the like. Further, the output unit 130 may include a display for an output of image signals or video signals, an audio output device for an output of audio signals, such as a speaker, and/or an ear jack, and a vibration module for an output of mechanical signals (e.g. vibration), and the like.

In addition, the mobile electronic device 100 may include a touch screen. The touch screen is one of user interfaces for interaction between a user and the mobile electronic device 100, and simultaneously performs both a function of a touch pad, which is a constituent element of the input unit 120, and a function of a display, which is a constituent element of the output unit 130. The touch screen may have a structure, in which a touch pad as an input element is combined with a display as an output element, or may have a structure, in which the touch pad and the display are integrally formed. A user may input instructions or information to the mobile electronic device 100 by directly touching a touch screen where a user interface is displayed, or by touching the touch screen with a stylus pen. Further, the mobile electronic device 100 may output texts, images, and/or videos to a touch screen for a user.

The controlling unit 110, e.g., the notification manager 112, may provide a specific user interface (UI) through a touch screen for interaction with a user to perform a notification function. For example, the notification manager 112 may provide, through a touch screen, a user interface for category classification, priority setting, display time, and notification icons, and for a black list and/or a white list setting with respect to programs and/or applications for executing notification functions.

The memory unit 140 is configured to store applications and data for operation of the mobile electronic device 100. More specifically, the memory unit 140 may store various types of applications to be processed and controlled by the controlling unit 110, for example OS programs, application programs, and programs for implementing function modules, such as the notification manager 112. Further, the memory unit 140 may store data or information, such as mails, texts, images, videos, documents, music, phone numbers, phone call records, and messages. There is no particular limit for a type of the memory unit 140, and the memory unit 140 may include a random access memory (RAM), an internal flash memory, an external flash memory including a USIM memory, a magnetic-disc memory, a read only memory (ROM), and the like.

Further, programs for the mobile electronic device 100 to perform a notification function may be stored in the memory unit 140. The memory unit 140 may temporarily store notification information to be displayed in the notification window, and, for this purpose, the memory unit 140 may include the screen buffer 142. However, the screen buffer 142 may be included in a separate memory. The memory unit 140 may also store information (i.e., priority information, category information, notification time information, a black list and a white list) regarding a display method of notification information determined by a user.

The sensing unit 150 may include a gravity sensor, a proximity sensor, an accelerometer, a motion sensor, an illuminance sensor, and the like. The wireless communication unit 160 is configured to transmit and receive electromagnetic waves to communicate with a wireless communications network, and/or with other electronic devices, and may include a mobile communication unit for voice, video, and data communications according to mobile communication standards, a WiFi communication unit for communications through a wireless local area network (WLAN), a near field communication unit for near field communications, and the like.

Further, the mobile electronic device 100 may further include a camera unit (not shown), or a power supply unit (not shown), or the like. The camera unit is configured to obtain image/video signals. The power supply unit is configured to supply power for the operation of the mobile electronic device 100 to each internal constituent element thereof, and may include a battery that is detachable, or integrally mounted thereon, as a power source.

Hereinafter, a notification method of a mobile electronic device will be described.

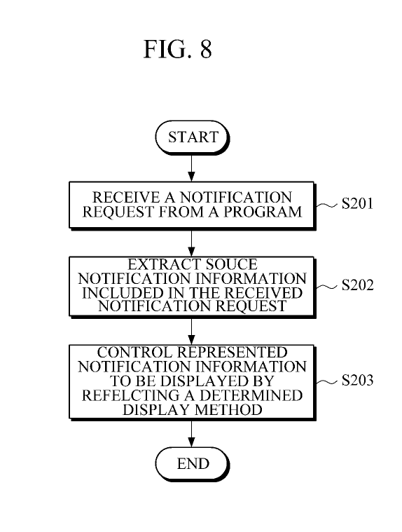

FIG. 8 is a flowchart illustrating an example of a notification method of a mobile electronic device according to an exemplary embodiment of the present invention. The notification method illustrated in FIG. 8 may be a method that is implemented in the mobile electronic device 100 including the notification manager 112, as described above with reference to FIG. 2, FIG. 3A, and FIG. 3B. Further, a display method of notification information may be predetermined by a user according to the method for setting notification information described above with reference to FIG. 4A to FIG. 7B, and the controlling method described above with reference to FIG. 4A to FIG. 7B may be applied to a method in which a notification manager 112 displays notification information in a notification window according to a determined display method. Therefore, a notification method of a mobile electronic device will be concisely described hereinafter, and the above description with reference to FIG. 2 to FIG. 7B may be applicable for notification methods described below.

With reference to FIG. 2 and FIG. 8, a notification request is received from a program installed in the mobile electronic device 100 (operation S201). The notification request may be received by the controlling unit 110, e.g., the notification manager 112 of the mobile electronic device 100. Further, source notification information including notification icons, notification messages, and the like, information for instructing operations to be executed when there is an input from a user to notification messages listed in a notification list, and intrinsic identification information for identifying notification requests (identification information may include identification information for a notification request itself, as well as identification information of programs that deliver a notification request) are received along with notification requests, or may be included in the notification requests received by the notification manager 112.

In operation S202, the notification manager 112 extracts source notification information, which is received along with notification requests, or included in notification requests to obtain notification information to be displayed in the notification window, e.g., notification information corresponding to notification requests. The source notification information may be extracted and used even when the source notification information is not displayed as its original form and is changed to modified notification information (or represented notification information) according to a display method determined by a user. Here, the modified notification information may be other images or texts different from original images or texts of the source notification information (see FIG. 6A to FIG. 6C). In the operation S202, in addition to source notification information, information to instruct operations to be executed when there is an input from a user to notification messages listed in a notification list, or intrinsic identification information to identify notification requests may also be extracted.

Further, the notification manager 112 controls represented notification information, which is notification information corresponding to notification requests by applying a display method determined by a user, to be displayed in a notification window (operation S203). Here, a notification method may be determined before implementing the notification method. Further, the display method determined by a user in the operation S203 may be applied to the source notification information extracted in the operation S202. A specific method in which the notification manager 112 controls notification information to be displayed in a notification window by applying the display method is described in detail above with reference to FIG. 4A to FIG. 7C, and the like, and thus, a detailed description thereof will be omitted.

Further, as shown in e.g., FIG. 5C, a user may register one or more applications for notification filtering or notification authorization. If the white list policy is adopted by a user, for example, the user may register one or more applications in the white list. According to this configuration, notification information associated with the applications registered in the white list may be displayed in a status indicator bar and notification information associated with other applications may be filtered from displaying in the status indicator bar. In another example, notification information associated with the applications registered in the white list may be indicated by various output devices, e.g., a display, a speaker, a vibrator, and other applications may be filtered and such notification requests may be ignored. If both the white list policy and the black list policy are adopted by a user, notification information associated with the applications registered in the white list may be processed by the second notification managing unit 112b based on a user-configured notification policy, notification information associated with the applications registered in the black list may be filtered and ignored, and notification information associated with other applications may be processed by the first notification managing unit 112a according to a default notification setting. In this configuration, the applications registered in the white list may have higher priorities than other applications. Further, a notification request may be filtered and ignored if notification information associated with the notification request includes a text or a word registered in a black list.

If one application includes multiple types of notifications, the notifications of the same application may be categorized into one group and one notification icon for the application may represent all notifications related to the application. More specifically, one notification icon may represent a notification related to the application and may be displayed in a status indicator bar. If a user touches the status indicator bar and retrieves a notification list, the grouped notification list may be displayed as shown in FIG. 7A. For example, the phone call application may have the first priority and all types of notifications related to the phone call application may be grouped into one item displayed in the notification list in FIG. 7A. If the user selects the item displayed in the notification list in FIG. 7A, e.g., T store application, different types of notification information related to the T store application may be displayed in detail.

According to aspects of the present invention, a method for displaying notification information in a notification window of a limited size may be determined arbitrarily by a user. For example, if there is a large amount of notification information to be displayed at the same time, a user may enable only some important information to be displayed in a notification window according to their preferences or convenience. Further, a user may arbitrarily set a time for displaying notification information in a notification window, and may determine notification information to be displayed per program, and/or per category. In addition, details of notification information (e.g., types of notification icons, or display method of notification messages) to be displayed in a notification window may be set arbitrarily by a user. As a result, even in a mobile electronic device having a notification window of a limited size, a notification function may be performed sufficiently, and notification information to be displayed may be managed efficiently.

If notification allowed time and/or notification prohibited time is set as shown in e.g., FIG. 4A to FIG. 4C, one or more notification events may be filtered, ignored, or hidden. Further, a notification of an application having a lower priority may be hidden from displaying in a status indicator bar and/or a notification list. Such hidden notification list may be registered in a hidden notification list and may be displayed in response to a user's input for retrieving the hidden notification list.

According to aspects of the present invention, the controlling unit 110 may include a notification manager having additional functionalities to provide a user-configurable notification policy or a notification manager having a second notification management unit 112b separated from a first notification management unit 112a to provide a user-configurable notification policy. The controlling unit 110 receives a notification request from an installed program or application and processes the notification request based on a user-configured notification policy. The controlling unit 110 may control the output unit 120 to output processed notification information based on the user-configured notification policy. The output notification information may be modified by a notification manager by various modification schemes, e.g., a filtering, a time range setting, an icon modification, a priority setting, display space management, a grouping of notifications for an application, a categorizing of notifications based on different application categories or application types, or the like. The output unit 120 may include an output device, such as a display, a touch screen display, a vibrator, a light emitter, a speaker, a sound generator, and the like or may operate in association with the output device.

The methods according to the above-described exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A mobile terminal to provide an interface for user notification, comprising:
a memory to store an application, the application providing a notification request in response to an event;
a controller to receive the notification request and, in response to the notification request, to process notification information based on a user-configured notification policy; and
an output device to output the processed notification information associated with the application.

2. The mobile terminal of claim 1, wherein the outputted notification information is modified based on the user-configured notification policy.

3. The mobile terminal of claim 2, wherein the modification of the outputted notification information comprises at least one of a modification of a default notification icon of the application, a modification of a notification priority for the application, and a grouping of multiple notification requests.

4. The mobile terminal of claim 1, wherein the controller comprises a notification manager to process the notification information by filtering, prioritizing, or modifying source notification information, based on the user-configured notification policy, and to generate the processed notification information to be output by the output device.

5. The mobile terminal of claim 4, wherein the memory comprises a screen buffer to store the source notification information or the processed notification information to be output by the output device.

6. The mobile terminal of claim 1, wherein the controller comprises a first notification manager to receive the notification request and a second notification manager to process the notification information based on the user-configured notification policy.

7. The mobile terminal of claim 1, wherein the controller determines the output of the notification information based on a time range.

8. The mobile terminal of claim 7, wherein the time range comprises at least one of a time range for allowing notification information output and a time range for prohibiting notification information output.

9. The mobile terminal of claim 1, wherein the controller controls a display of a time range setting screen for setting a time range associated with a notification output, the time range configured to be set by a user input.

10. The mobile terminal of claim 1, wherein the controller provides a priority setting screen for setting or editing a notification priority of the application.

11. The mobile terminal of claim 1, wherein the controller provides a notification icon setting screen for editing a notification icon of the application.

12. A method for providing an interface for user notification, the method comprising:
storing an application, the application providing a notification request in response to an event;
receiving the notification request;
in response to the notification request, processing notification information based on a user-configured notification policy; and
outputting the processed notification information associated with the application.

13. The method of claim 12, wherein the outputted notification information is modified based on the user-configured notification policy.

14. The method of claim 13, wherein the modification of the outputted notification information comprises at least one of a modification of a default notification icon of the application, a modification of a notification priority for the application, and a grouping of multiple notification requests.

15. The method of claim 12, wherein the processing of the notification information comprises filtering, prioritizing, or modifying source notification information, based on the user-configured notification policy, and generating the processed notification information to be output by an output device.

16. The method of claim 12, further comprising determining the output of the processed notification information based on a time range.

17. The method of claim 16, wherein the time range comprises at least one of a time range for allowing notification information output and a time range for prohibiting notification information output.

18. The method of claim 12, further comprising controlling a display of a time range setting screen for setting a time range associated with a notification output, the time range configured to be set by a user input.

19. The method of claim 12, further comprising providing a priority setting screen for setting or editing a notification priority of the application.

20. The method of claim 12, further comprising providing a notification icon setting screen for editing a notification icon of the application.
